(19) United States
(12) Patent Application Publication
(10) Pub. No.: US 2016/0132787 A1
(43) Pub. Date: May 12, 2016

(54) DISTRIBUTED, MULTI-MODEL, SELF-LEARNING PLATFORM FOR MACHINE LEARNING

(71) Applicants: Will D. Drevo, Cambridge, MA (US); Kalyan K. Veeramachaneni, Brighton, MA (US); Una-May O'Reilly, Weston, MA (US)

(72) Inventors: Will D. Drevo, Cambridge, MA (US); Kalyan K. Veeramachaneni, Brighton, MA (US); Una-May O'Reilly, Weston, MA (US)

(73) Assignee: Massachusetts Institute of Technology, Cambridge, MA (US)

(21) Appl. No.: 14/598,628

(22) Filed: Jan. 16, 2015

Related U.S. Application Data
(60) Provisional application No. 62/078,052, filed on Nov. 11, 2014.

(51) Int. Cl. G06N 99/00

(52) U.S. Cl. CPC G06N 99/005

(57) ABSTRACT

A system is provided for multi-methodology, multi-user, self-optimizing Machine Learning as a Service for that automates and optimizes the model training process. The system uses a large-scale distributed architecture and is compatible with cloud services. The system uses a hybrid optimization technique to select between multiple machine learning approaches for a given dataset. The system can also use datasets to transferring knowledge of how one modeling methodology has previously worked over to a new problem.

### CROSS REFERENCE TO RELATED APPLICATION

This application claims the benefit under 35 U.S.C. §119(e) of U.S. Provisional Application No. 62/078,052 filed Nov. 11, 2014, which application is incorporated herein by reference in its entirety.

### BACKGROUND

Given a dataset D consisting of N supervised learning example (data point, label) pairs, a data scientist may be interested in identifying a model that can accurately predict a label for a previously unseen data point. To choose among multiple models, a data scientist may evaluate the models using a metric such as accuracy, precision, recall, and F1-score (for classification) and mean absolute error (MAE), mean squared error (MSE), and other norms (for regression). To estimate a model's generalizability, k-fold cross-validation may be employed. To select among modeling methodologies, however, remains an open and fundamental challenge. Over the past two decades, different methodologies such as support vector machines (SVM), neural networks (NN) and Bayesian networks (BN) have matured while new ones, such as deep neural networks (DNN), deep belief networks (DBN) and stochastic gradient descent (SGD), have emerged. A data scientist does not know apriori which methodology will result in the best performing model. To make the challenge more difficult, tuning a methodology can have a large impact on performance because a given methodology may have numerous parameters and design choices.

Consider for example, a DBN model. In most cases, a data scientist needs to choose a number of layers and a transfer function for each layer. Then, the data scientist further needs to choose a number of hidden units for each layer and values for continuous parameters, such as learning rate, number of epochs, pre-training learning rate, and learning rate decay. Even if the number of layers is limited to a small-discretized range and the transfer functions are limited to a few choices, the number of combinations (i.e. search space) may be quite large. While state-of-art data science toolkits, e.g. H₂O, so provide convenient interfaces for selecting among parameters and choices when modeling, they do not address how to choose between modeling methodologies or how to make design and parameter choices within a given methodology.

As another example, given an unseen supervised classification dataset, there are a variety of options for building predictive models, such as decision trees, NN, SGD, and logistic regression, among others. Further, each modeling methodology has its own parameters, kernels, and distance metrics that make tuning each type of model difficult. Today, most work focuses on optimizing a single model type with Bayesian hyperparameter optimization, or simply conducting a random grid search, both of which are costly processes that can consume high compute and require extended time periods to train.

The online platform KAGGLE in some sense enables this search problem to be solved. It promises prizes for the most accurate models. Thus it enlists data scientists across the world to seek out the best modeling methodology, its parameters and choices. Lamentably, no (or little) experience is shared among KAGGLE's competitors so it is likely that many combinations are explored more than once. Further, no knowledge of methodology selection has resulted. Despite the large number of problems solved by KAGGLE competitions, no evidence-based recommendations currently exist for which methodology to use and how to set parameters.

### SUMMARY

It is appreciated herein that it would be useful to avoid iteratively optimizing an the entire space of parameters and design choices for every modeling methodology, while at the same time identifying an optimum model (or finding a model close to the optimum model) with less computational effort. In addition, knowledge (or experience) of how one methodology has previously worked should be transferred to new problems, such that model recommendations can improve over time.

Accordingly, a system is provided for multi-methodology, multi-user, self-optimizing Machine Learning as a Service for that automates and optimizes the model training process. The system uses a large-scale distributed architecture and is compatible with cloud services. The system uses a hybrid optimization technique to select between multiple machine learning approaches for a given dataset. The system can also use datasets to transferring knowledge of how one modeling methodology has previously worked over to a new problem.

The system can support different workflows based on whether the user is able to share the data or not. One workflow utilizes a “machine learning as-a-service” technique and is made available to all data scientists (with non-commercial use cases). The other workflow allows a user to obtain model recommendations while maintaining their datasets in private.

According to one aspect of the disclosure, a system is provided to automate selection and training of machine learning models across multiple modeling methodologies. The system comprises: a model methodology repository configured to store one or more model methodology implementations, each of the model methodology implementations associated with a modeling methodology; a dataset repository configured to store datasets; a data hub configured to store data run records and performance records; a dataset upload interface (UI) configured to receive a dataset, store the received dataset within the dataset repository, to generate a data run record comprising the location of received dataset within the dataset repository, and to store the generated data run record to the data hub; and a processing cluster comprising a plurality of worker nodes, each of the worker nodes configured to select a data run record from the data hub, to select a dataset from the dataset repository, to select a modeling methodology from the model methodology repository; to generate a parameterization within with the model methodology, to generate a model having the selected modeling methodology and generated parameterization, to train the generated model on the selected dataset, to evaluate the performance of the trained model on the selected dataset, to generate a performance record, and to store the generated performance record to the data hub.

In some embodiments, each of the data run records comprising a dataset location identifying one of the stored datasets within the dataset repository, wherein the each of the worker nodes is configured to select a dataset from the dataset repository based upon the dataset location identified by the data run record. In certain embodiments, each of the performance records may be associated with a data run record and a modeling methodology, and each of the performance records comprising a parameterization within the associated modeling methodology and performance data indicating the performance of the model parameterization on the associated dataset, wherein each of the worker nodes is configured to and to generate a performance record comprising the evaluated performance and associated with the selected data run, the selected modeling methodology, and the generated parameterization.

In various embodiments of the system, the dataset UI is further configured to receive one or more parameters and to store the one of more parameters with a data run record. The parameters may include a wall time budget, a performance threshold, number of models to evaluate, or a performance metric. In some embodiments, at least one of the worker nodes is configured to correlate the performance of models on a first dataset to the performance of models on a second dataset.

In certain embodiments, at least one of the worker nodes is configured to use a Bandit strategy to optimize a model for a dataset and, thus, the parameters may include a Bandit strategy memory type, a Bandit strategy reward type, or a Bandit strategy grouping type. In various embodiments, at least one of the worker nodes is configured to use a Gaussian Process (GP) model to select a model for a dataset, wherein the selected model maximizes an acquisition function and, thus, the parameters may include the acquisition function.

In some embodiments, the system further comprises a trained model repository, wherein at least one of the worker nodes is configured to store a trained model within the trained model repository.

According to another aspect of the disclosure, a method for machine learning comprises: (a) generating a plurality modeling possibilities across a plurality of modeling methodologies; (b) receiving a first dataset; (c) selecting a first plurality of models from the modeling possibilities; (d) evaluating a performance of each one of the first plurality of models on the first dataset; (e) receiving a second dataset; (f) selecting a second plurality of models from the modeling possibilities; (g) evaluating a performance of each one of the second plurality of models on the second dataset; (h) receiving a third dataset; (i) selecting a third plurality of models from the modeling possibilities; (j) evaluating a performance of each one of the third plurality of models on the third dataset; (k) generating a first performance vector comprising the performance of each one of the first plurality of models on the first dataset; (l) generating a second performance vector comprising the performance of each one of the second plurality of models on the second dataset; (m) generating a third performance vector comprising the performance of each one of the third plurality of models on the third dataset; (n) selecting from the first and second datasets, the most similar dataset based upon comparing a similarity between the first and third performance vectors and a similarity between the second and third performance vectors; (o) among the models trained for the most similar dataset, select the one with the highest performance on the most similar dataset; (p) evaluating a performance of the selected model on the third dataset; (q) add the performance of the selected model on the third dataset to the third performance vector, and (r) returning a model from the third performance vector having a highest performance of models in the third performance vector. The steps (n)-(r) may be repeated until the model having the highest performance from the third performance vector has a performance greater than or equal to a predetermined performance threshold, a predetermined wall time budget is exceeded, and/or performance of a predetermined number of models is evaluated.

In some embodiments of the method, evaluating the performance of each one of the first plurality of models on the first dataset comprises storing a plurality of performances records to a database, wherein generate a first performance vector comprising the performance of each one of the first plurality of models on the first dataset comprises retrieving the first plurality of performance records from the database, wherein each of the plurality of performance records is associated with the first dataset and one of the first plurality of models, wherein each of the plurality of performance records comprises performance data indicating the performance of the associated model on the first dataset.

In various embodiments, the method further comprises: estimating the performance of one or more of the modeling possibilities not in the third plurality of models on the third dataset using collaborative filtering or matrix factorization techniques; and adding the estimated performances to the third performance vector.

In certain embodiments of the method, generating a plurality modeling possibilities across a plurality of modeling methodologies comprises: enumerating a plurality of hyperpartitions across a plurality of modeling methodologies; and for optimizable model parameters and hyperparameters, choose a feasible step size to derive a plurality of modeling possibilities.

According to another aspect of the disclosure, a method for machine learning comprises: (a) receiving a dataset; (b) enumerating a plurality of hyperpartitions across a plurality of modeling methodologies; (c) generating a plurality initial models, each of the initial models associated with one of the plurality of hyperpartitions; (d) evaluating a performance of each of the plurality of initial models on the dataset; (e) providing a Multi-Armed Bandit (MAB) comprising a plurality of arms, each of the arms corresponding to at least one of the plurality of hyperpartitions; (f) calculating a score for each of the MAB arms based upon the performance of evaluated models associated with the corresponding at least one of the plurality of hyperpartitions; (g) choosing a hyperpartition based upon the MAB arm scores; (h) generating a Gaussian Process (GP) model using the performance of evaluated models associated with the chosen hyperpartition; (i) generating a plurality of proposed models, each of the modeling possibilities associated with the chosen hyperpartition; (j) estimating a performance of each of the proposed models using the GP model; (k) choosing a model from the proposed models maximizing an acquisition function; (l) evaluating the performance of the chosen model on the dataset; and (m) returning a model having the highest performance on the dataset of the models evaluated. The steps (f)-(l) may be repeated until a model having the highest performance on the dataset has a performance greater than or equal to a predetermined performance threshold, a predetermined wall time budget is exceeded, and/or performance of a predetermined number of models is evaluated.

In various embodiments of the method, providing a Multi-Armed Bandit (MAB) comprises providing a MAB having a plurality of arms, each of the arms corresponding to at least two of the plurality of hyperpartitions associated with the same modeling methodology. In some embodiments, choosing a hyperpartition based upon the MAB arm scores comprises choosing a hyperpartition using an Upper Confidence Bound-1 (UCB1) algorithm.

Calculating a score for each of a MAB arm may include calculating a score based upon: the performance of the most recent K evaluated models associated with the corresponding at least one of the plurality of hyperpartitions; the performance of a best K evaluated models associated with the corresponding at least one of the plurality of hyperpartitions; an average performance of evaluated models associated with the corresponding at least one of the plurality of hyperpartitions; and/or a derivative of the performance of evaluated models associated with the corresponding at least one of the plurality of hyperpartitions.

### BRIEF DESCRIPTION OF THE DRAWINGS

The concepts, structures, and techniques sought to be protected herein may be more fully understood from the following detailed description of the drawings, in which:

FIG. 1 is a block diagram of a distributed, multi-model, self-learning system for machine learning;

FIG. 2 is a diagram of a schema for use within the system of FIG. 1;

FIGS. 3, 3A, and 3B are diagrams of illustrative Conditional Parameter Trees (CPTs) for use within the system of FIG. 1;

FIG. 4 is a flowchart of an illustrative Initiate-Correlate-Recommend-Train (ICRT) routine for use within the system of FIG. 1;

FIG. 4A is a flowchart of an illustrative initialization process for use with the ICRT routine of FIG. 4;

FIG. 4B is a diagram of an illustrative data-model performance matrix for use with the ICRT routine of FIG. 4;

FIG. 5 is a flowchart of an illustrative hybrid model optimization process for use within the system of FIG. 1;

FIG. 5A is a diagram of an illustrative Multi-Armed Bandit (MAB) for use within the hybrid model optimization process of FIG. 5;

FIG. 6 is a flowchart of an illustrative model recommendation and optimization method for use within the system of FIG. 1;

FIG. 7 is a flowchart of an illustrative model training process for use within the system of FIG. 1; and

FIG. 8 is a schematic representation of an illustrative computer for use with the system of FIG. 1.

The drawings are not necessarily to scale, or inclusive of all elements of a system, emphasis instead generally being placed upon illustrating the concepts, structures, and techniques sought to be protected herein.

### DETAILED DESCRIPTION

Before describing embodiments of the concepts, structures, and techniques sought to be protected herein, some terms are explained. As used herein, the term “modeling methodology” refers to a machine learning technique, including supervised, unsupervised, and semi-supervised machine learning techniques. Non-limiting examples of model methodologies include support vector machine (SVM), neural networks (NN), Bayesian networks (BN), deep neural networks (DNN), deep belief networks (DBN), stochastic gradient descent (SGD), and random forest (RF).

As used herein, the term “model parameters” refer to the possible settings or choices for a given modeling methodology. These include categorical choices, such as a kernel or transfer function, discrete choices, such as number of epochs, and continuous choices such as learning rate. The term “hyperparameters” refers to model parameters that are relevant when certain choices are made for other model parameters. In other words, hyperparameter are conditioned on other parameters. For example, when Gaussian kernel is chosen for a SVM, a value for a (i.e., the mean) may be specified; however, if a different kernel were selected, the hyperparameter a would not apply.

The term “hyperpartition” is a subset of all parameters for a given methodology such that the values for categorical parameters are constrained (or “frozen”). Stated differently, a hyperpartition is obtained after selecting among all the categorical parameters for a model. The hyperparameters for these categorical parameters and the rest of the model parameters (e.g., discrete and continuous parameters) enumerate a sub-search space within a hyperpartition.

As used herein, the term “model” is used to describe modeling methodology along with its parameters and hyperparameter settings. The term “parameterization” may be used synonymously with the term “model” herein. A “trained model” is a model that has been trained on one or more datasets.

A modeling methodology and, thus, a model may be implemented using an algorithm or other suitable processing sometimes referred to as a “learning algorithm,” “machine learning algorithm,” or “algorithmic model.” It should be understood that a model/methodology could be implemented using hardware, software, or a combination thereof.

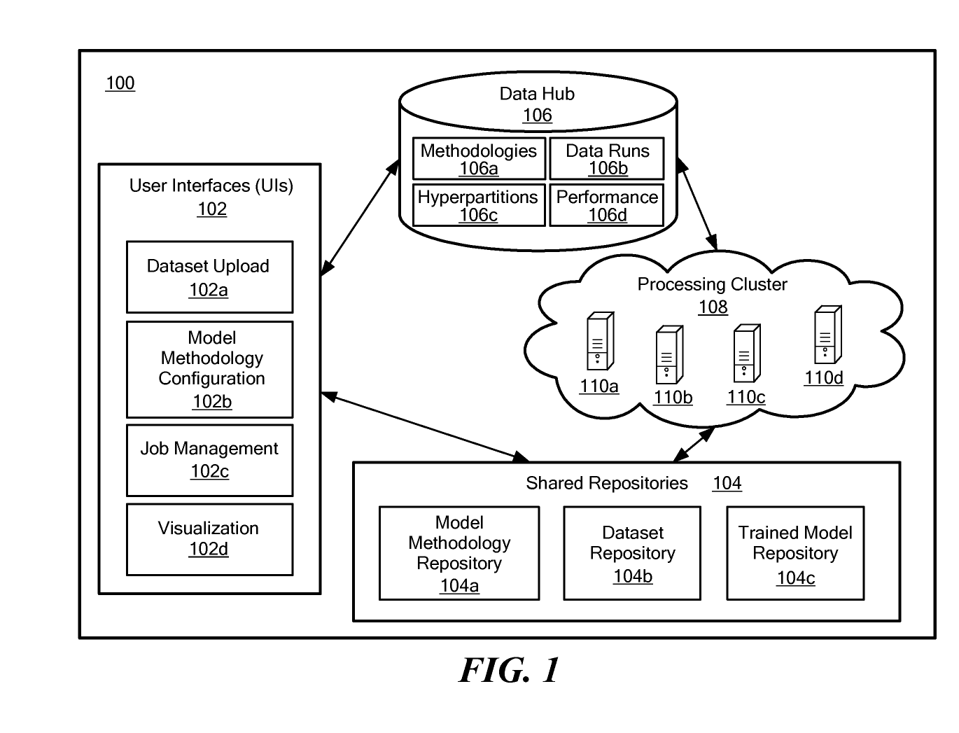

Referring to FIG. 1, an illustrative distributed, multi-model, self-learning system 100 for machine learning includes user interfaces (UIs) 102, shared repositories 104, a data hub 106, and a processing cluster 108. The UIs 102 and processing cluster 108 may be operatively coupled to read and write data to the shared repositories 104 and/or data hub 106, as shown.

The shared repositories 104 include one or more storage facilities which can be used by the UIs 102 and/or processing cluster 108 to read and write data. The repositories 104 may include any suitable storage mechanism, including a database, hard disk drive (HDD), Flash memory, other non-volatile memory (NVM), network-attached storage (NAS), cloud storage, etc. In certain embodiments, the shared repositories 104 are provided a shared file system, such as NFS (Network File System), which is accessible to the UIs 102 and processing cluster 108. In certain embodiments, the shared repositories 104 comprise a Hadoop Distributed File System (HDFS).

In the embodiment shown, the shared repositories 104 include a model methodology repository 104a, a dataset repository 104b, and a trained model repository 104c. The model methodology repository 104a stores implementations of various modeling methodologies available within the system 100. Such implementations may correspond to computer instructions that implement processing routines or algorithms. In some embodiments, methodologies can be added and removed via a model methodology configuration UI 102b, as described below. In other embodiments, the model methodology repository 104a is generally static, including built-in or “hardcoded” methodologies.

The dataset repository 104b stores datasets uploaded by users. In certain embodiments, the dataset repository 104b corresponds to a cloud storage service, such as Amazon's Simple Storage Service (S3). In general, datasets are stored only temporarily within the repository 104b and removed after a corresponding data run terminates.

The trained model repository 104c stores models trained by the system 100, e.g., models trained as part of the model recommendation, training, and optimization techniques described below. The trained models may be stored temporarily (e.g., until provided to the user) or long-term. By storing trained models on a long-term basis, the system allows for retrospective creation of ensembles. In addition, storing trained models allows for retrieving a best model in a different hyperpartition if later it is desired to change model types.

The data hub 106 is a data store used by the processing cluster 108 to coordinate data run processing work in a distributed fashion and to store corresponding model performance data. The data hub 106 can comprise any suitable data store, including commercial (or open source) off-the-shelf database systems such as relational database management systems (RDBMS) (e.g., MySQL, SQL Server, or Oracle) or key/value store systems (e.g., such as MongoDB, CouchDB, DynamnoDB, or other so-called “NoSQL” databases). Accordingly, information within the data hub 106 can be accessed by users via a diverse set of tools and UIs written in many types of programming languages.

Using the data hub 106, the system 100 can store many aspects of the model exploration search process: model training times, measures of predictive power, average performance for evaluation, training time, number of features, baselines, and comparative performance among methodologies. In some respects, the data hub 106 serves as a high-performance, immutable log for model performances (e.g., classifier performances), dataset attributes, and error reporting. In addition, the data hub 106 may serve as the coordinator for worker nodes within the processing cluster 108, as discussed further below.

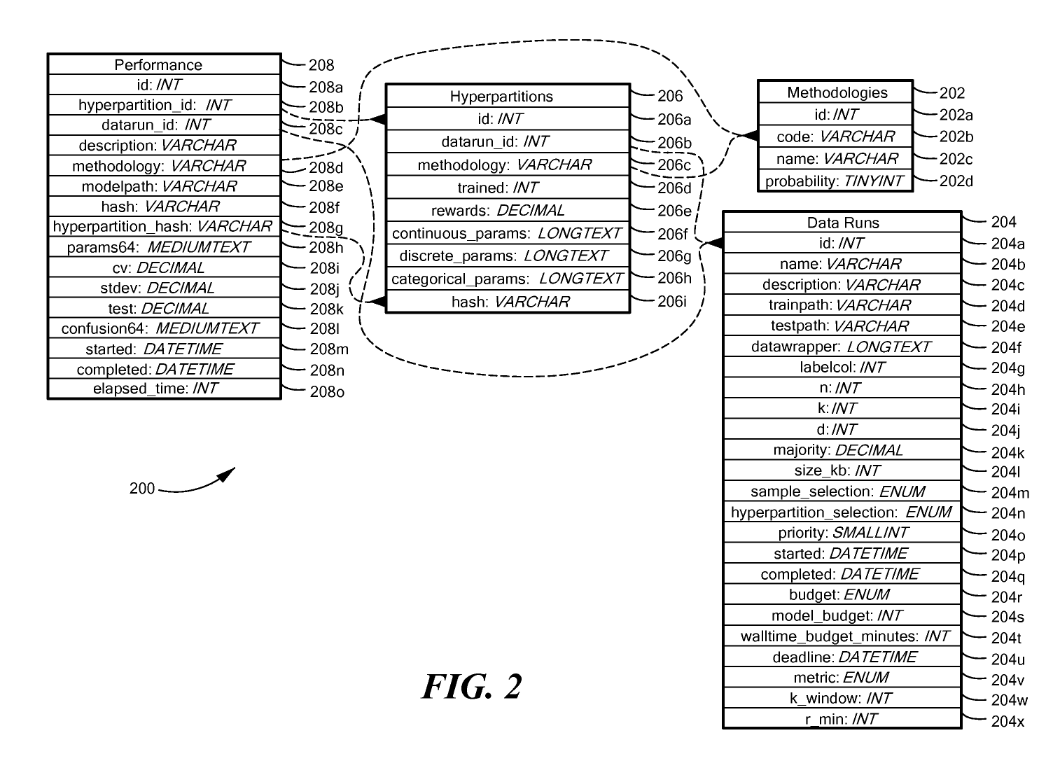

The data hub 106 includes one or more tables, which may correspond to tables (i.e., relations) within an RDBMS, or tables (sometimes referred to as “column families”) within a key/value store. A table includes an arbitrary number of records, which may correspond to rows in a relational database or a collection of key-value pairs within a key/value store. In the embodiment shown, the data hub 106 includes a methodologies table 106a, a data runs table 106b, a hyperpartitions table 106c, and a performance table 106d. Although each of these tables is described in detail below in conjunction with FIG. 2, a brief overview is given here.

The methodologies table 106a tracks the modeling methodologies available to the processing cluster 108. Records within the table 106a may correspond to implementations available within the model methodology repository 104a.

The data runs table 106b stores information about processing tasks for specific datasets within the system 100. A record of table 106b is associated with a dataset (stored within the repository 104b) and includes processing instructions and termination criteria. The data runs table 106b can be used as a FIFO and/or priority queue by the processing cluster 108.

The hyperpartitions table 106c stores, the performance of a particular modeling methodology hyperpartition for a given dataset.

The performance table 106d stores performance data for models trained for given datasets. A record of table 105d is associated with a methodology 106a, a dataset 106b, and a hyperpartition 106c, and includes a complete model parameterization along with evaluated performance information. In some embodiments, the processing cluster 108 use the performance table as an immutable log, appending and reading data, but not editing or deleting records.

The illustrative UIs 102 include a dataset upload UI 102a, an model methodology configuration UI 102b, a job management UI 102c, and a visualization UI 102d. The UIs may be graphical user interfaces (GUIs) configured to execute upon a computer or other suitable processing device. A user (e.g., a data scientist) can interact with the UIs using a user input device (e.g., a keyboard, a mouse, voice control, or a touchscreen) and a user output device (e.g., a computer monitor or a touchscreen). Alternatively, the UIs may correspond to application programming interfaces (APIs), which a user or external system can use to programmatically interface with the system 100. In some embodiments, the system 100 provides a Hypertext Transfer Protocol (HTTP) API.

The UIs 102 may include authentication and access control features to limit access to various system functionality on a per-user basis. For example, the system 100 may generally any user to utilize the dataset upload UI 102a, while only allowing system operators to access the model methodology configuration UI 102b.

The dataset upload UI 102a can be used to import datasets to the system 100 and create corresponding data run records 106b. In general, a dataset includes a plurality of examples, each example having one or more features and, in the case of a supervised dataset, a corresponding class (or “label”).

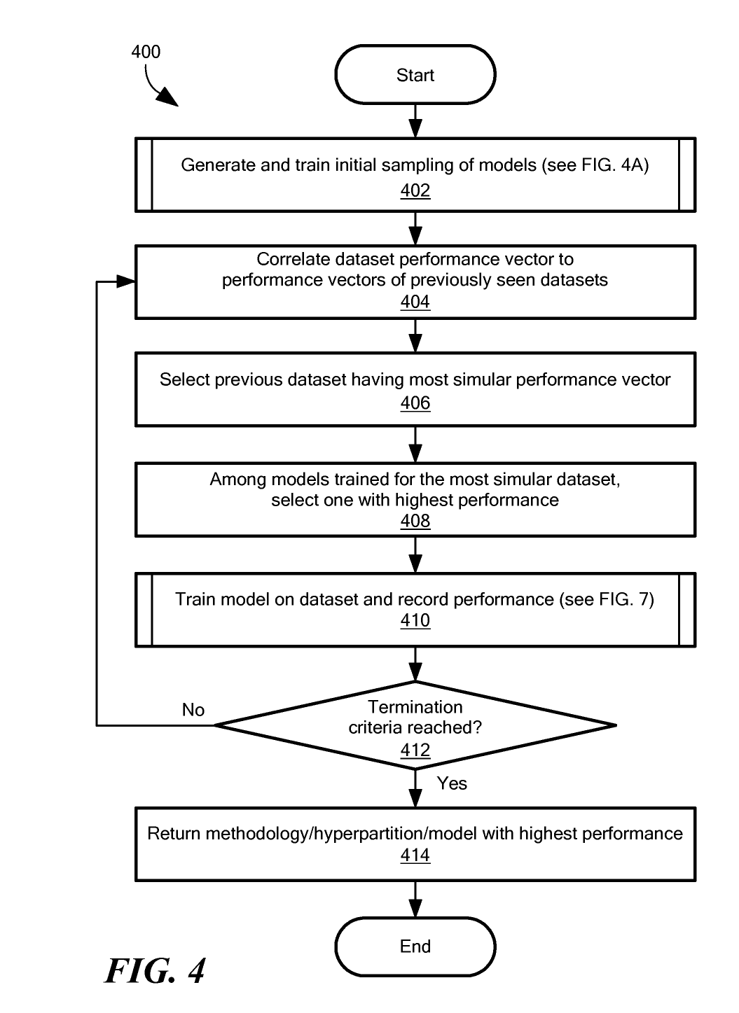

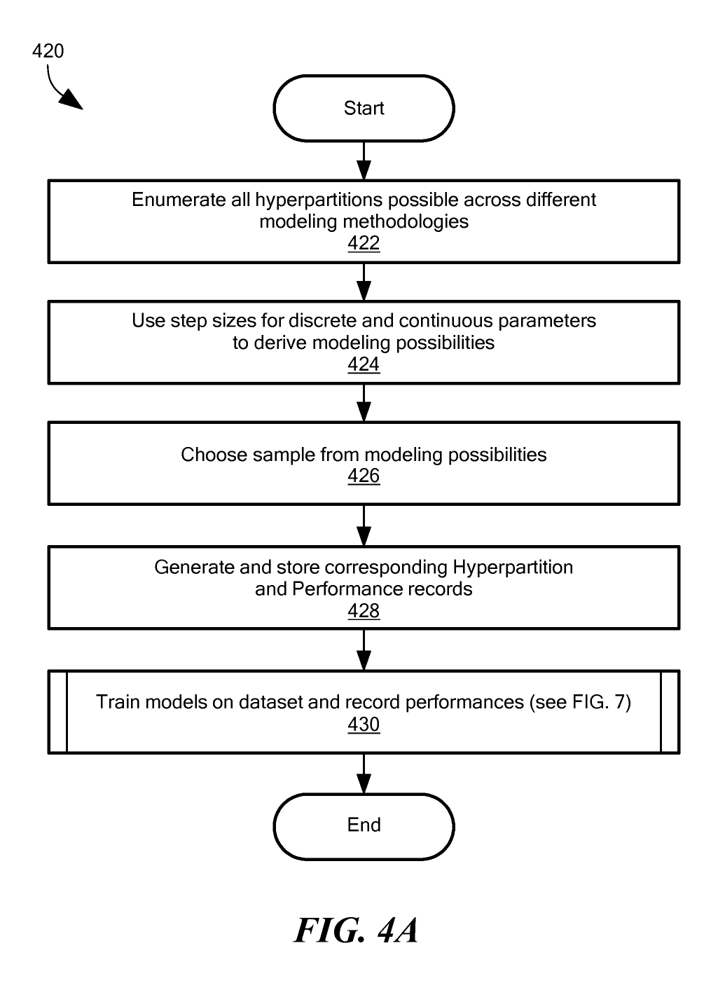

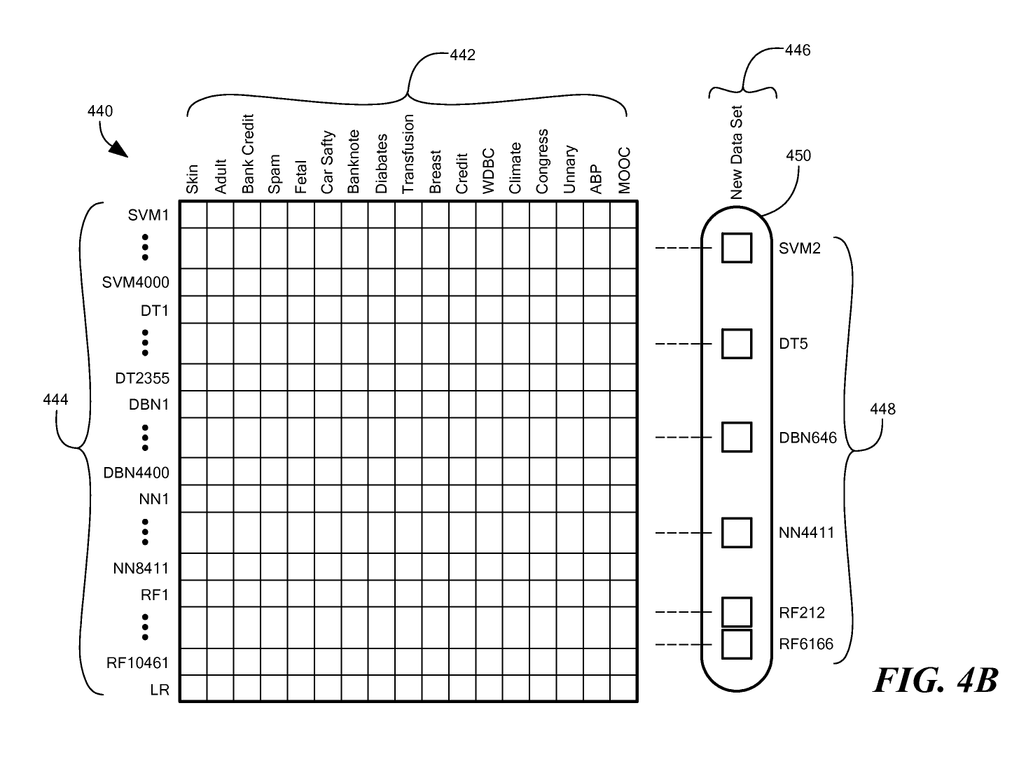

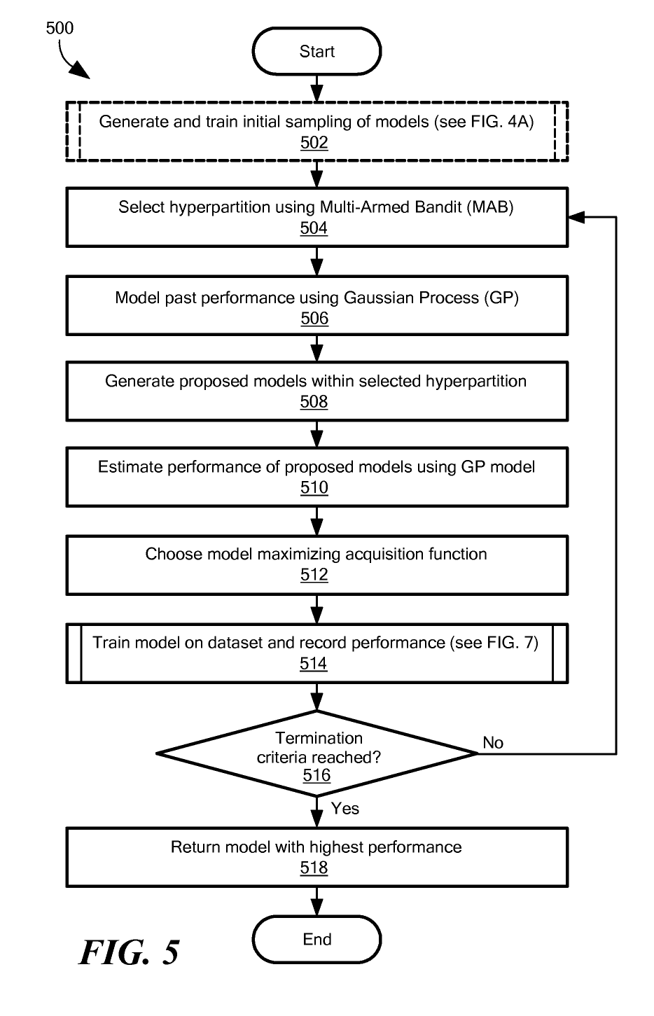

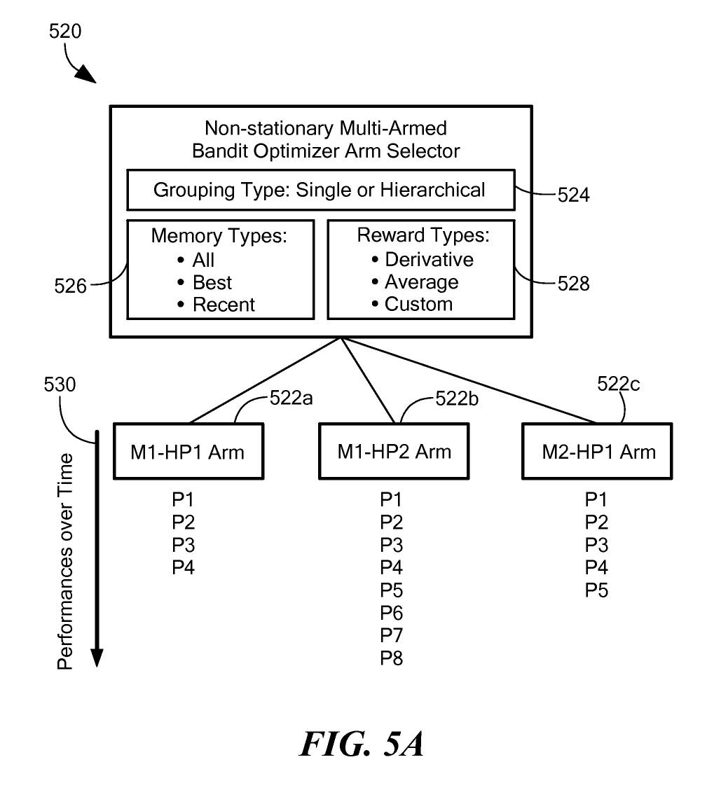

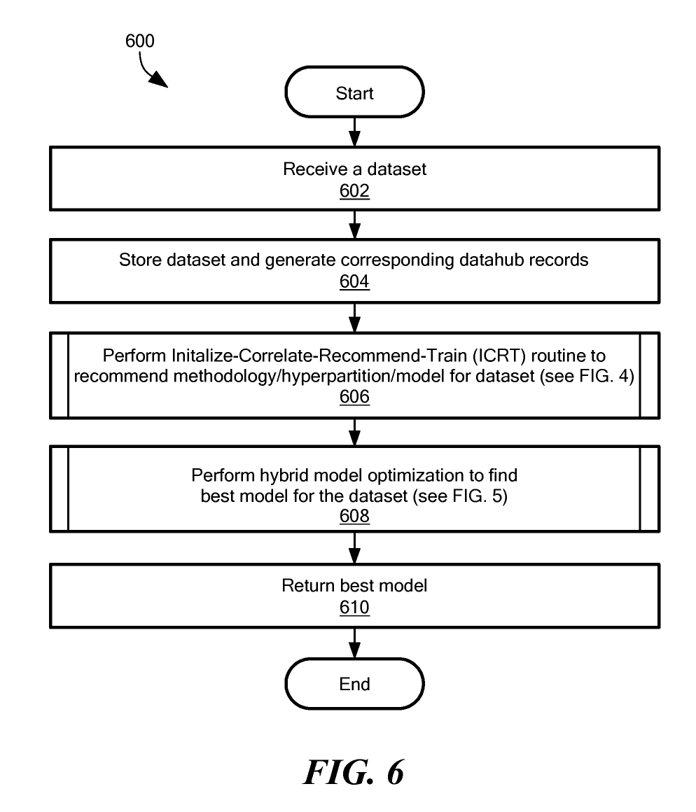

The dataset upload UI 102 can accept uploads in one or more formats. For example, a supervised classification dataset may be provided as a comma-separated value (CSV) file having a header row specifying the feature names, and one row per example specifying the corresponding feature values. It will be appreciated that the CSV format is commonly used within business world and supported by widely used tools like Microsoft Excel and OpenOffice. Alternatively, a user could upload Principal Component Analysis (PCA) or Single Value Decomposition (SVD) data for a dataset. As is known, these techniques utilize eigenvectors, eigenvalues, or compressed data and can be used in conjunction with routines/processes described below in conjunction with FIGS. 4, 4A, 5, 6, and 7.

The uploaded dataset may be stored in the dataset repository 104b, where it can be accessed by the processing cluster 108. In some embodiments, dataset upload UI 102a accepts uploads in multiple formats, and converts uploaded datasets to a normalized format used by the processing cluster 108. In various embodiments, a dataset is deleted from the repository 104b after a data run completes and corresponding result data is returned to the user.

In some embodiments, a user can uploaded a training dataset and a corresponding testing dataset, wherein the training dataset is used to train a candidate model and the test dataset is used to measure the performance of the trained model using a specified performance metric. The training and testing datasets may be uploaded as a single file partitioned into training and testing portions. The training and test datasets may be stored separately within the dataset repository 104b.

In conjunction with uploading datasets via the upload UI 102, a user can configure various parameters of a data run. For example, the user can specify a hyperpartition selection strategy, a hyperparameter tuning strategy, a performance metric to optimize, a budget, a priority level, etc. The system 100 can use the priority level to prioritize among multiple pending data runs. A budget can be specified terms of maximum execution time (“walitime”), maximum number of models to train, or any other suitable criteria. The user-specified parameters are stored within the data runs table 106b, along with the location of the uploaded dataset. The system 100 may provide default values for any data run parameters not explicitly specified.

In some embodiments, the system 100 can email the results of a data run (e.g., a trained model) to the user. Accordingly, the user can configure one or more email addresses which would also be stored within the data runs table 106b.

TABLE 1

[run]
methodologies: classify_svm, classify_dt, classify_dbn
priority: 5
sendto: john.smith@some.email, jane.doe@another.email
[budget]
budget-type: walltime
walltime-budget: 100
[strategy]
sample_selection: gp_eivel
hyperpartition_selection: purebestkvel
metric: cv
k_window: 5
r_min: 4

In some embodiments, a user can configure a data run by specifying parameters via a configuration file. The configuration file may utilize a conventional properties file format known in the art. TABLE 1 shows an example of such a configuration file.

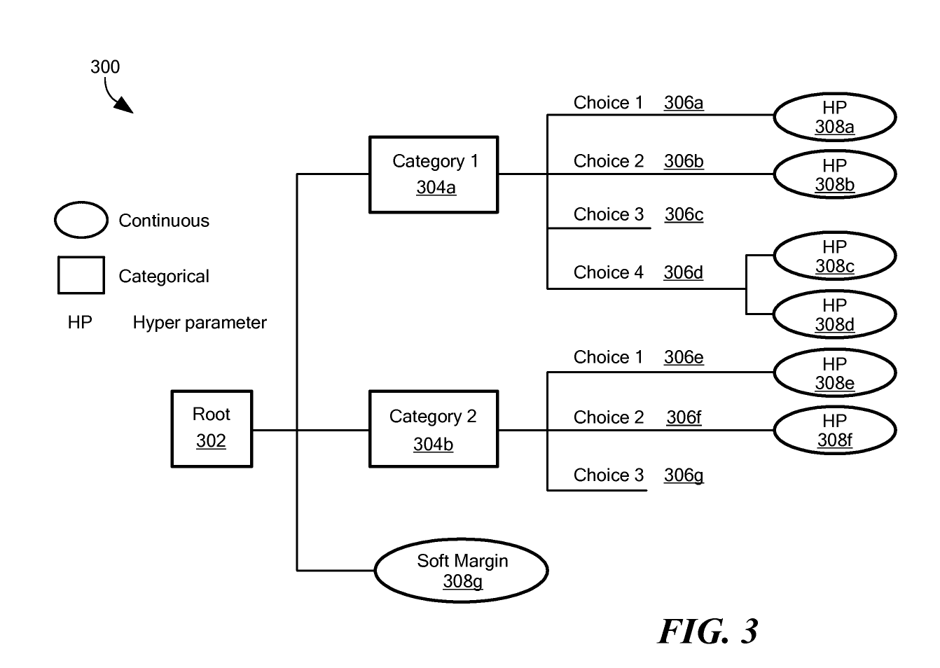

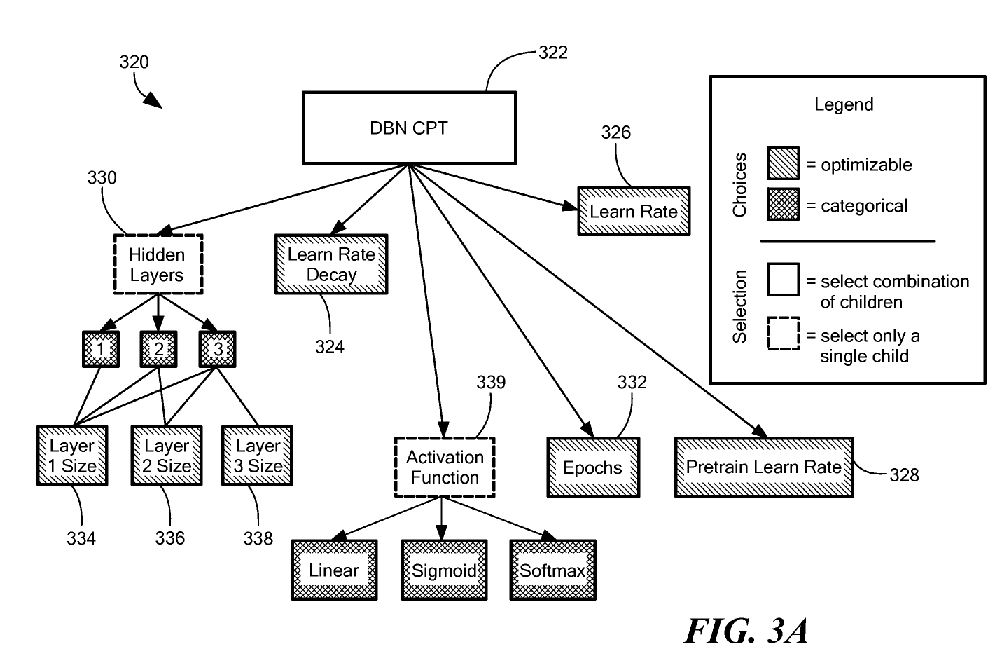

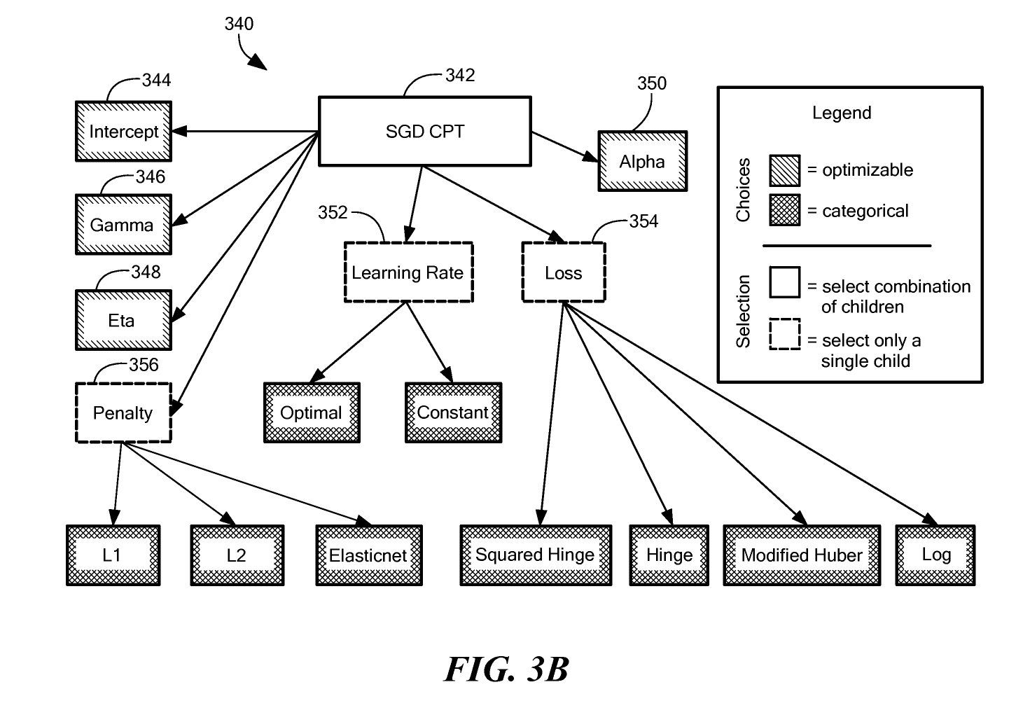

The model methodology configuration UI 102b can be used to add and remove model methodologies from the system. The system 100 may be provided with one or more built-in methodologies for handling both supervised and supervised tasks. Using the UI 102b, a user can provide additional methodologies for handling both supervised and unsupervised tasks of all types, not just classification, so long as the methodologies can be conditionally parameterized and a success metric evaluated. In some embodiments, a user can add a custom machine learning algorithm from a third-party toolkit or in a specific programming language. Thus, the system 100 provides a standardized model methodology API. A developer/user creates a bridge between the API methods and their custom methodology implementation (e.g., algorithm) and then conditionally map the parameters using so-called Conditional Parameter Trees (“CPTs”, described below in conjunction with FIGS. 3, 3A, and 3B) to facilitate the system 100's creation of hyperpartitions for optimization. The underlying model methodology can be provided in any programming language (i.e., a programming language supported by the processing cluster 108), including scripting languages, interpreted languages, and natively compiled languages. The system 100 is agnostic to the modeling methodologies being run on it, so long as they function and return a score, the system can attempt to tune parameters.

In various embodiments, when a methodology is added via the model methodology configuration UI 102b, an implementation (e.g., computer instructions) is stored within the repository 104a and a corresponding record is added to the data hub methodologies table 106a. A corresponding CPT may also be stored within the model methodology repository 104a.

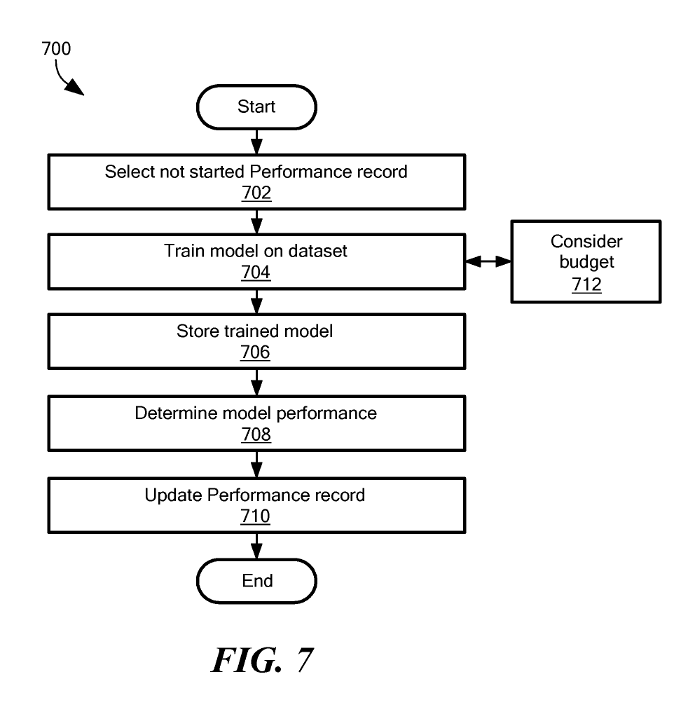

The job management UI 102c can be used to manage jobs within the system 100. The term “job” is used herein to refers to a discrete task performed by a worker node 110, such as training a model on a dataset and storing the model performance to the is performance table 106d, as described below in conjunction with FIG. 7. By breaking individual model trainings into discrete jobs, the system 100 can employ distributed processing techniques. A user may use the job management UI 102c to monitor the status of jobs and to start and stop jobs as desired.

The visualization UI 102d can be used to review model training information stored within the data hub 106. As will be appreciated, the system 100 records many aspects of the model search process within the data hub 106, including model training times, measures of predictive power, average performance for evaluation, training time, number of features, baselines, and comparative performance among models and modeling techniques. The visualization UI 102 can present this information using graphs, tables, and other graphical controls.

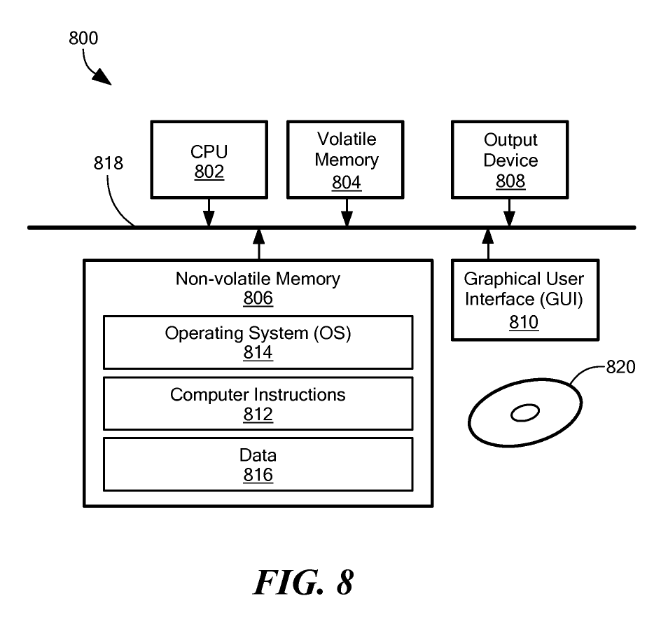

The processing cluster 108 comprises one or more worker nodes 110, with four worker nodes 110a-110d shown in this example. A worker node 110 includes a processing device (e.g., processing device 800 of FIG. 8) configured to execute processing described below in conjunction with FIGS. 4, 4A, 5, 6, and 7. The worker nodes 110 may correspond to separate physical and/or virtual computing platforms. Alternatively, two or more worker nodes 110 may be collocated on a shared physical and/or virtual computing platform.

The worker nodes 110 are coupled to read/write data to/from the shared repositories 104 and the data hub 106. In some embodiments, the worker nodes 110 communicate via the data hub 106 and no inter-worker communication is needed to process a data run. More specifically, a worker node 110 can efficiently query the data hub 106 to identify data runs and/or model trainings that need to be processed, perform the corresponding processing, and record the results back to the data hub 106, which implicitly notifies other worker nodes 110 that the processing is complete. The data runs may be processed using a first-in first-out (FIFO) policy, providing a queuing mechanism. The worker nodes 106 may also consider priority levels associated with data runs when selecting jobs to perform. Within a data run, the job ordering can be dynamic and based on, for example, hyperpartition reward performance which dictates arm choice in a Multi-Armed Bandit (MAB), and selects hyperpartitions to pick and set parameters from, and then train the model. Advantageously, all processing can be performed by the distributed worker nodes 110 and no central server or central logic required.

To accommodate the a large number of concurrent users, datasets, and data runs, the processing cluster 108 may comprise (or utilize) an elastic, cloud-based distributed machine learning platform that trains and evaluates many models (e.g., classifiers) simultaneously, allowing many users to obtain model recommendations concurrently.

In some embodiments, the processing cluster 108 comprises/utilizes an Openstack cloud or a commercial cloud computer service, such as Amazon's Elastic Cloud Compute (EC2) service. Worker nodes 110 may be added as needed to handle additional requests. In some embodiments, the processing cluster 108 includes an auto-scaling feature, whereby worker nodes 110 are automatically added and removed based on usage and available resources.

In general operation, a user uploads data via the dataset upload UI 102a (FIG. 1), specifying various processing instructions, termination criteria, and other parameters for the data run. The dataset is stored within the dataset repository 104b and a corresponding record is added to the data runs table 106b, informing the processing cluster 108 of available work. In turn, the worker nodes 100 coordinate using the hyperpartitions and performance tables 106c, 106d to recommend, optimize, and/or train a suitable model for the dataset using the methods described below in conjunction with FIGS. 4, 4A, 5, 6, and 7. A resulting model can be delivered to the user and the uploaded dataset deleted from the system 100. The user can track the progress of the data run and/or view the results of a data run via the job management UI 102c and/or the visualization UI 102d.

Referring to FIG. 2, an illustrative schema 200 may be used within the data hub 106 of FIG. 1. The schema 200 includes a methodologies table definition 202, a data runs table definition 204, a hyperpartitions table definition 206, and a performance table definition 208. Each of the tables definitions 202, 204, 206, and 208 includes a plurality of attributes which may correspond to columns with the respective tables 106a, 106b, 106c, and 106d of FIG. 1. In the embodiment shown, each of the table definitions 202, 204, 206, and 208 include a respective id attribute 202a, 204a, 206a, and 208a, which uniquely identify records within the database. The id attributes 202a, 204a, 206a, and 208a may be synthetic primary keys generated by a database.

The methodologies table definition 202 further includes a code attribute 202b, a name attribute 202c, and a probability attribute 202d. The code attribute 202b may be a user-specified string value that uniquely identifies the methodology within the system 100.

The name attribute 202c may also be specified by a user. For example, a user may specify code 202b “classify_dbn” and corresponding name 202c “Deep Belief Network.” As another example, a user may specify code 202b “regression_gp” and corresponding name 202c “Gaussian Process.” The probability attribute 202d is a flag (i.e., a true/false attribute) indicating whether the methodology provides a probabilistic prediction.

The data runs table definition 204 further includes a name attribute 204b, a description attribute 204c, a training path attribute 204d, a testing path attribute 204e, a data wrapper attribute 204f, a label column attribute 204g, a number of examples attribute 204h, a number of classes attribute 204i (for classification problems), a number of dimensions (i.e., features) attribute 204j, a majority attribute 204k, a dataset size (in kilobytes) attribute 204l, a sample selection strategy attribute 204m, a hyperpartition selection strategy attribute 204n, a priority attribute 204o, a started timestamp attribute 204p, a completed timestamp attribute 204q, a budget type attribute 204r, a model budget attribute 204s, a wall time budget (in minutes) attribute 204t, a deadline attribute 204u, a metric attribute 204v, a window attribute 204w, and an rₘᵢₙ attribute 204x.

The training and testing path attributes 204d, 204e represents the location of the training and testing datasets, respectively, within the repository 104b. These values may be file system paths, Uniform Resource Locators (URLs), or any other suitable locators. For a given data run record, if the corresponding dataset is split into separate files for training versus testing, the paths 204d and 204e will be different; otherwise they will be the same.

The data wrapper attribute 204f specifies a serialized binary object describing how to extract features from the uploaded dataset, wherein features may be treated as categorical, ordinal, numeric, etc. The label column attribute 204g specifies which column of the dataset (e.g., which CSV column) corresponds to the label column. The majority attribute 204k specifies the percentage of examples in the dataset that correspond to the majority class; this attribute serves as a benchmark when accuracy is used as a performance metric.

The sample selection strategy attribute 204m specifies an acquisition function to use for model optimization, as discussed below in conjunction with FIG. 5. Non-limiting examples of sample selection types include: “uniform,” “gp” (Gaussian Process), “gp_ei” (Gaussian Process Expected Improvement), and “gp_eitime” (Gaussian Process Expected Improvement per Time). The hyperpartition selection strategy attribute 204n specifies the Multi-Armed Bandit (MAB) strategy to use, as discussed below in conjunction with FIGS. 5 and 5A. Non-limiting examples of hyperpertitions selection types include: “uniform,” “ucb1” (the Upper Confidence Bound-1 or UCB-1 algorithm), “bestk” (Best K memory strategy), “bestkvel” (Best K memory strategy with velocity), “recentk” (Recent K memory strategy), “recentkvel” (Recent K memory strategy with velocity), and “hieralg” (Hierarchical grouping).

The budget type attribute 204r specifies whether no budget should be used (“none”), a wall time budget should be used (“walltime”), or a number-of-models-trained budget should be used (“models”). For a wall time budget, the wall time budget attribute 204t specifies the maximum number of minutes to complete the data run. For a number-of-models-considered budget, the models budget attribute 204s specifies the maximum number of models that should be evaluated (i.e., trained on the dataset and evaluated for performance) during the data run.

The metric attribute 204v specifies the metric to use when evaluating models, such as “precision,” “recall,” “accuracy,” and “F1.” The k_{window} and rₘᵢₙ attributes 204w, 204x are described below in conjunction with FIGS. 5 and 5A.

The hyperpartitions table definition 206 further includes a data runs foreign key attribute 206b, an methodologies foreign key attribute 206c, a number of models trained attribute 206d, a cumulative MAB rewards attribute 206e, an attribute 206f to specify the continuous (or “optimizable”) parameters for a hyperpartition, an attribute 206g to specify the discrete parameters and corresponding values (i.e. “constants”) for a hyperpartition, an attribute 206h to specify the list of categorical values and corresponding values for a hyperpartition, and a hash attribute 206i. Values for parameter attributes 206f, 206g, and/or 206h may be provided as binary objects encoded as text (e.g., using Base64 encoding). The hash attribute 206i is a hash of the parameter values 206f, 206g, and/or 206h, which provides a unique identifier for the hyperpartition that is portable across database implementations.

The performance table definition 208 further includes a hyperpartition foreign key attribute 208b, a data run foreign key attribute 208c, a methodologies foreign key attribute 208d, a model path attribute 208e, a hash attribute 208f, a hyperpartitions hash attribute 208g, an attribute 208h to specify model parameters and corresponding values, an average (e.g., mean) performance attribute 208i, a performance standard deviation attribute 208j, a testing score of metric 208k, a confusion matrix attribute 208l (used for classification problems), a started timestamp attribute 208m, a completed timestamp attribute 208n, and an elapsed time (in seconds) attribute 208o. The model path attribute 208e specifies the location of a model within the trained model repository 104c. Values for the parameters attribute 208h and confusion matrix attribute 208l may be provided as binary objects encoded as text (e.g., using Base64 encoding). The hash attribute 208f is a hash of the parameters 208h, which provides a unique identifier for the model that is portable across database implementations.

FIGS. 3, 3A, and 3B show illustrative Conditional Parameter Trees (CPTs) that could be used within the system 100 of FIG. 1. To programmatically search for the “best” model for a dataset, the system 100 must be able to enumerate parameters, generate acceptable inputs are for each parameter, and designate continuous, integer-valued, or 2o categorical parameters. When searching spaces of multiple modeling methodologies, a number of challenges to finding the best model arise either in the isolation of one methodology or from an aggregation. In particular, the following challenges can be expected.
Discontinuity and non-differentiability: Categorical parameters make the search space non differentiable and do not yield to simple search techniques like hill climbing or methods that rely on learning about the search space (e.g. Bayesian optimization approaches).
Varying dimensions of the search space: Hyperparameters, by definition, imply that the hyperpartitions within a methodology have different dimensions. Because choosing one categorical variable over another can imply a different set of hyperparameters, the dimensionality of a hyperpartition also varies.
Non-transferability of methodology performance: Unfortunately when conducting search among modeling methodologies, robust heuristics are limited. For example, training on the dataset with an SVM model provides no indication of how a DBN model might perform.

For example, a Support Vector Machine (SVM) can be represented as a function, which takes varied arguments (or “parameters”)

model=f(X,y,c,kernel,gamma,degree,cachesize).

To find a suitable (and ideally, the best) SVM for a dataset, the system 100 must enumerate all combinations of parameters. This process is complicated by the fact that certain parameters may depend on other parameters. For example, the “kernel” parameter may take any of the values “linear,” “polynomial,” “RBF” (Radial Basis kernel (RBF), or “sigmoid.” A “polynomial” kernel would necessitate choosing a positive integer value for “degree,” while the choice of “RBF” would not. Likewise, the “sigmoid” kernel may require its own “gamma” value. Thus, the parameter “degree” is conditional on the selection of “polynomial” for the kernel, and hence is a referred to herein as a “conditional” parameter, while the choice of “kernel” may be required for all SVM models.

Accordingly, the system 100 represents conditional parameter spaces as a tree-based data structure referred to herein as a Conditional Parameter Tree (CPT). A CPT is abstraction that compactly expresses every parameter, hyperparameter and design choice, in general, for a modeling methodology. This representation allow system 100 to both generate parameterizations and learn from previously attempted parameterizations by correlating their performance to suggest new parameterizations and find the best predictive model.

Referring to FIG. 3, the structure of CPTs is described using a generic CPT 300. A CPT 300 expresses a modeling methodology's option space, which includes combined discrete, categorical, and/or continuous parameters as well as any hyperparameters. In general, nodes of a CPT represent parameter choices (or conditional combinations) and certain parameter choice can cause another to be chosen. Edges of a CPT generally represent the choices that could be made when a corresponding parent node is selected.

Alternatively, choices may be represented by a plurality of nodes (referred to herein as “choice nodes”) that directly descend from a categorical node.

Each node in a CPT has two attributes: whether it is categorical or non-categorical, and whether its children should be selected as a combination or as an exclusive choice. Non-categorical parameters include continuous and certain discrete valued parameters that can be optimized or tuned, and are therefore referred to herein as “optimizable” parameters. Categorical parameters are choices that cannot be optimized and are used to partition model option spaces into hyperpartitions. A node marked as exclusive implies that only one of its children can to be chosen, while a node marked as a combination implies that for each of its children, a single choice must be made to compose a parameterization of the classification model.

The leaves of a CPT correspond to parameters or hyperparameters. Between the root and leaves, special parent nodes for categorical parameters designate whether they are selected in combination or whether just one categorical child is selected. Continuous parameters descend directly from the root while hyperparameters descend from categorical parameters.

The illustrative generic CPT 300 includes a root node 302, categorical parameter nodes 304, choice nodes 306, and continuous nodes 308. In this example, the CPT 300 includes two categorical parameter nodes 304a-304b, six choice nodes 306a-306g, and seven continuous parameter nodes 308a-308g, as shown. Continuous parameter nodes 308a-308f are conditional on choice nodes 306 and, thus, correspond to hyperparameters. For example, node 308a represents a hyperparameter that “exists” only when “Choice 1” (node 306a) is selected for “Category 1” (node 304a). As another example, nodes 308c and 308d represent hyperparameters that “exist” only when “Choice 4” (node 306d) is selected for “Category 1” (node 304a).

It will be appreciated that a CPT can be recursively traversed to enumerate a methodology's search space and generate all possible model parameterizations.

Referring to FIG. 3A, an illustrative CPT 320 can represent an option space for deep belief network (DBN), as indicated by root node 322. The CPT 320 includes three continuous parameters: learn rate decay 324, learn rate 326, and pretrain learn rate 328; two discrete parameters: hidden layers 330 and epochs 332; and a single categorical parameter: activation function 339. Depending upon the choice for the number of hidden layers 330, a discrete value is chosen for the sizes of one, two, or three hidden layers (i.e., a discrete value is chosen for Layer 1 Size 334; for Layer 1 Size 334 and Layer 2 Size 336; or for Layer 1 Size 334, Layer 2 Size 336, and Layer 3 Size 338). Thus, leaf nodes 334, 336, and 338 correspond to hyperparameters.

From the CPT 320, nine hyperpartitions can be derived by selecting (or “freezing”) values for the categorical parameters 330 and 339. An example hyperpartition for DBN is (Hidden Layers-1, Activation Function=linear, Epochs, Learn Rate, Pretrain Learn Rate, Learn Rate Decay, Layer 1 Size). Within this hyperpartition, the system 100 can optimize for the parameters “Epochs” (node 332), “Learn Rate” (node 326), “Pretrain Learn Rate” (node 328), “Learn Rate Decay” (node 324), and “Layer 1 Size” (node 334).

Referring to FIG. 3B, another illustrative CPT 340 represents an option space for stochastic gradient descent (SGD), as indicated by root node 342. The CPT 340 includes four continuous parameters: intercept 344, Gamma 306, Eta 348, and Alpha 350; and three categorical parameters: Learning rate 352, Loss 354, and Penalty 356. Twenty-four hyperpartitions can be formed from the CPT 340.

In order to use a model methodology within the system 100 (FIG. 1), a corresponding CPT can be defined using any suitable technique. For example, a CPT can be defined using an API that instructs the system how to enumerate all the possible combinations given possible choices and conditional dependencies, ensuring that each sample is valid and has no redundant parameters.

It will be appreciated that CPTs solves challenges of searching spaces of multiple modeling methodologies, including discontinuity and non-differentiability, varying dimensions of the search space, and non-transferability of methodology performance.

FIGS. 4, 4A, 5, 6, and 7 are flowcharts corresponding to below contemplated techniques that would be implemented in the system 100 of FIG. 1. Rectangular elements (typified by element 404 in FIG. 4), herein denoted “processing blocks,” represent computer software instructions or groups of instructions. Rectangular elements having double vertical bars (typified by element 402 in FIG. 4), herein denoted “sub-processing blocks,” represent groups of computer software instructions.

Diamond shaped elements (typified by element 412 in FIG. 4), herein denoted “decision blocks,” represent computer software instructions, or groups of instructions, which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the concepts, structures, and techniques sought to be protected herein. Thus, unless otherwise stated the blocks described below are unordered meaning that, when possible, the functions represented by the blocks can be performed in any convenient or desirable order.

FIG. 4 is a flowchart of an illustrative Initiate-Correlate-Recommend-Train (ICRT) routine 400 for use within the system 100 of FIG. 1. ICRT is a technique for transferring knowledge (or experience) of how one modeling methodology has previously worked over to a new problem using datasets a vehicle to transfer such knowledge. The general approach is similar to that of movie recommender systems: while movies and viewers could be represented with a number of attributes, rather than expressing them to predict how much a movie would be liked, other viewer's rating of movies are exploited. Similarly, ICRT considers models as movies and datasets as people. The ICRT routine 400 can be used to recommend a modeling methodology, a specific hyperpartition within that methodology, or even a specific model (i.e., a parameterization) within that hyperpartition.

At block 402, an initial sampling of models is generated and trained using. FIG. 4A is a flowchart of an initialization process that may correspond to the processing of block 402.

Referring briefly to FIG. 4A, at block 422, all hyperpartitions are enumerated across the different modeling possibilities defined within the system 100 (e.g., within the methodologies table 106a). The hyperpartitions may be enumerated using CPTs defined as binary objects stored within the model methodology repository 104a.

At block 424, for continuous and discrete (i.e., optimizable) parameters and hyperparameters, a feasible step size is chosen to derive the possible modeling possibilities. For the purposes of ICRT, the enumerated modeling possibilities should generally remain constant across datasets so that model performance can effectively be correlated across datasets.

For a relatively small number of methodologies, hundreds or even thousands of modeling possibilities may be derived. Due to processing and/or time constraints, it may be impractical or undesirable to train all modeling possibilities on each dataset. Thus, at block 426, a relatively small number of models are selected (or “sampled”) from the set of modeling possibilities. In some embodiments, the models are sampled randomly. The number of models selected may be specified by a user and stored with the data run, e.g. stored within the rₘᵢₙ attribute 204x in FIG. 2.

At block 428, for each of the selected models, a performance record is generated and stored in data hub table 106d. In addition, for each distinct hyperpartition within the selected models, a hyperpartition record is generated and stored in data hub table 106c. Each performance records is associated with a hyperpartition record via the foreign key attribute 208b and with the data run record via the foreign key attribute 208c (FIG. 2). Likewise, each hyperpartition record is associated with the data run record via the foreign key attribute 206b (FIG. 2). The generated performance records correspond to jobs (or “tasks”) that can be performed by worker nodes 110.

At block 430, the selected models are trained on the received dataset and the performance of each model is determined and recorded to the data hub 106. It should be understood that the models may be trained by many different worker nodes 110 in a distributed fashion. Such work can be coordinated using the data hub 106, as shown in FIG. 7 and described below in conjunction therewith. After a model is trained, a worker node 110 updates the corresponding performance record with the model's performance.

Returning to FIG. 4, the performance of all models trained on the dataset is used to generate a so-called “data-model performance matrix,” denoted M_{k,i}. Initially, this will include those models trained as part of the initial sampling of block 402. A data-model performance matrix includes performance information about L datasets, denoted l=1 . . . L, which have been previously seen by the system 100. Each cell of the matrix M_{k,l} holds the performance of a model k on a dataset l. When a new dataset is evaluated, the performance for each initially trained model k is stored in M_{k,L+1}, where L+1 corresponds to the new dataset. As described below, the data-model performance matrix can be used to correlate past experience to improve recommendation results over time.

An illustrative data-model performance matrix (or, more simply, “performance matrix”) 440 is shown in FIG. 4B. The performance matrix 440 includes a plurality of modeling possibilities 444 (shown as rows) and a plurality of datasets 442 (shown as columns). The modeling possibilities 444 may correspond to those enumerated/derived at block 422 of FIG. 4A. The datasets 442 correspond to datasets previously evaluated by the system 100. Each cell of the performance matrix 440 corresponds to the performance of a model on the corresponding dataset. If a model has not been evaluated for a given dataset, the corresponding cell is blank. In some embodiments, each non-blank cell of the performance matrix 440 corresponds to a performance record within the data hub 106. A column of a performance matrix 440 (or, in some embodiments, the non-blank portions thereof) is referred to as a “performance vector.” When a new dataset 446 is evaluated using the ICRT routine, one or more modeling possibilities 448 are initially selected and trained (block 402 of FIG. 4). Once the selected models are trained on the new dataset 446, corresponding performance data 450 can be added to the performance matrix 440.

It should be appreciated that the performance matrix 440 need not be explicitly stored within the system 100 but, rather, can be derived lazily from the data hub 106 as needed, either in full or in part. For example, performance vectors (i.e., columns) for a given dataset can be retrieved by querying the performance table 106d for records associated with a particular data run.

Returning to FIG. 4, at block 404, the performance of the received dataset is correlated to the performance of previously seen datasets. The goal is to find the most similar previously seen dataset to the received dataset based on known performance information. For each previously seen dataset, the performance vector x̅ of the received dataset is compared to the performance vector y̅ of the previously seen dataset using a similarity metric sim(x̅,y̅), where the performance vectors can be derived from the performance matrix M. In some embodiments, the similarity metric is based only on models actually trained for both the received dataset and the previously seen dataset (i.e., the performance vectors x̅ and y̅ are compared across models that were evaluated for both datasets). In other embodiments, the similarity metric is based on performance data that is “guessed” using collaborative filtering or matrix factorization techniques. In certain embodiments, the Pearson Correlation similarity metric is used, however any function that takes two vectors x̅ and y̅ and produces a similarity metric could be used.

More formally, given previously seen previously seen datasets l=1 . . . L and the received set L+1, the system may generate a z-score matrix M^{z}

$${M}_{k , l}^{z} = \frac{{M}_{k , l} - E [ {M}_{1 \text{:} K , l} ]}{Var [ {M}_{1 \text{:} K , l} ]} ∀ l , k \vert k ∈ {S}_{l}$$

where Sₗ represents the set of trained models on dataset l. Empty entries in the z-score matrix are ignored. For each previously seen dataset l in 1 . . . L, the system finds the commonly evaluated models C=Sₗ∩S_{L+1} and calculates the similarity α₁=sim(M_{k∈C,l}^{z}, M_{k∈C,L+1}). In some embodiments, the commonly evaluated models includes models for which performance has been estimated using collaborative filtering or matrix factorization techniques.

At block 406, the previous dataset having the most similar performance is selected

l*=argmax₁ αₗ

and, at block 408, among the models trained for the most similar dataset l*, the one with the highest performance is selected

k*=argmaxₗ M_{k,l*}|k∉S_{L+}1.

At block 410, the highest performing model k* is trained on the received dataset using, for example, the training process described below in conjunction with FIG. 7. The newly trained model may be evaluated for performance using the specified performance metric (e.g., the metric specified by attribute 204v of the data runs table 106b) and the results stored in the data hub (and, thus, within the performance matrix M.

The correlate-and-train processing of blocks 404-410 is repeated until certain termination criteria are reached (block 412). The termination criteria can include whether desired performance is reached, whether a computational or time-based budget (or “deadline”) is met, or any other suitable criteria. If the termination criteria is reached, the highest performing model k* is returned (or “recommended”) at block 414.

It will be appreciated that the illustrative method 400 seeks to find similarities between datasets by characterizing datasets using the performances of various models and model hyperpartitions. After a brief random exploratory phase to seed the performance matrix, the routine attempts at each model evaluation the highest performing untried model in the current most similar dataset.

FIG. 5 is a flowchart of a hybrid model optimization process 500 for use within the system of FIG. 1. The process 500 searches for the “best” model to use with a given dataset. Optimization is performed at both the hyperpartition level and the parameterization level using a hybrid strategy. First, a hyperpartition is chosen. Here, all hyperpartitions are treated equally and statistical methods are used to decide from which hyperpartition to sample from. For example, in choosing a hyperpartition, the system would be choosing between SVMs with RBF kernel, SVMs with linear kernels, Decision Trees with Gini cuts, and Decision Trees with entropy cuts, etc., all at the same level. After a hyperpartition has been chosen, a parameterization within the definition of that hyperpartition must be chosen. This next step is referred to as “hyperparameter optimization.”

At block 502, an initial sampling of models is generated and trained if a minimum number of models have not yet been trained for the dataset. In some embodiments, the minimum number of models is specified by the rₘᵢₙ attribute 204x of the data runs table 106b. FIG. 4A, which is described in detail above, shows an initialization process that may correspond to the processing of block 502. In some embodiments, the ICRT routine of FIG. 4 is performed prior to the model optimization process 500 and, thus, a sufficient number of models may already have been trained for the given dataset and, thus, block 502 may be skipped.

At block 504, a hyperpartition is selected by employing a MAB learning strategy. In general, to select between hyperpartitions, the system 100 employs Bandit learning strategies disclosed herein, which consider each hyperpartition (or group of hyperpartitions) as an arm in a MAB.

Turning to FIG. 5A, a MAB 520 is an agent with J arms 522 (with three arms 522a-522c shown in this example) that maximize reward by choosing arms, wherein each choice results in a reward. A MAB 520 includes certain design choices that affect performance, including a grouping type 524, a memory type 526, and a reward type 528. The system 100 may allow a user to specify such design choices via parameters stored in the data runs table 106b, as described further below.

Rewards in the MAB 520 are defined based on the performances achieved for the parameterizations so far sampled for the hyperpartition, where the initial performance data is generated by the sampling process (block 502) and subsequent performance data is generated in an iterative fashion by the process 500 (FIG. 5).

In some embodiments, the MAB 520 makes use of the Upper Confidence Bound-1 (UCB-1) algorithm for balancing exploration and exploitation. A UCB1 MAB 520 chooses (or “plays”) arms 522 that maximize

$$Arm Score = {\overline{y}}_{j} + \sqrt{\frac{2 ln n}{{n}_{j}}}$$

where j is the arm index, y̅ⱼ is the average reward seen from choosing arm j nⱼ times, and n=Σⱼ₌₁^{J}nⱼ over all J arms.

UCB1 treats each hyperpartition (or each group of hyperpartitions) as an arm 522 with its own distribution of rewards. Over time (shown indicated by line 530 in FIG. 5A), the MAB 520 learns more about the distribution and balances exploration and exploitation by choosing the most promising hyperpartitions to form parameterizations.

A reward y̅ⱼ formulation must be chosen to score and choose arms. As shown, the MAB 520 supports various reward types 528 including rewards based on average performance, reward based on a derivative of performance (e.g., velocity, acceleration, etc.), and custom reward types.

For rewards based on average, the reward y̅ⱼ is taken directly from the average performance (e.g., average 10-fold cross validation) for each yⱼ. This method has the benefit of preserving the regret bounds in the original UCB1 formulation.

For reward based on a derivative of performance, the MAB 520 seeks to rank hyperpartitions by a rate of change. For instance, using a velocity reward type, a hyperpartition whose last few evaluations have made large improvements should be exploited while it continues to improve. Using velocity, the reward formation is

$${\overline{y}}_{j} = \frac{1}{n} {\sum }_{j = 1}^{j} Δ {y}_{j}^{k}$$

for Δyⱼ^{k} in sorted time or score order, where k is determined by the memory strategy, as described below.

Derivative-based strategies are powerful because they introduce a feedback mechanism to control exploration and exploitation. For example, a velocity optimization strategy will explore each hyperpartition arm until its rate of increase in performance is less than others, going back and forth between hyperpartitions without wasting time on relatively less promising hyperpartitions.

The memory type 526 determines a memory (sometimes referred to as a “moving window”) strategy used by the MAB 520. Memory strategies are used to adapt the bandit formulation in the face of non-stationary distributions. UCB1 assumes that the underlying distribution for the rewards at each arm choice is static. If a distribution changes, the MAB 520 can fail to adequately balance exploration and exploitation. As described below, the hybrid optimization process 500 utilizes a Gaussian Process (GP) model that improves by learning about the hyperpartitions and which parameter settings are most sensitive, effectively shifting and reforming the bandit's perceived reward distribution. The distribution of model performances from the parameterizations within that hyperpartition does not change, but the bias with which the GP samples can. This causes the bandit to judge a hyperpartition based on stale rewards that do not represent how the GP will select parameterizations.

Memory strategies have a parameter k_{window} that determines the size of the moving window. A so-called “Best K” memory strategy utilizes the best k_{window} parameterizations and their corresponding rewards yⱼ in the formulation of y̅ⱼ. □A so-called “Recent K” memory strategy utilizes the most recently completed k_{window} parameterizations and corresponding rewards yⱼ in the formulation of y̅ⱼ. The MAB 520 may also support an “All” memory strategy, which is a special case of Best K where k_{window} is very large (effectively infinite). In embodiments, k_{window} can be specified by the user and stored in attribute 204w of the data runs table 106b.

The grouping type 524 specifies whether arms 522 correspond to individual hyperpartitions or whether hyperpartitions are grouped using a hierarchical strategy. In some embodiments, hyperpartitions are grouped by methodology. Within a hierarchical strategy, so-called “meta-arms” are constructed for which y̅ⱼ is the average of all yⱼ over all constituent hyperpartitions of the meta-arm group and the sum n=Σⱼ₌₁^{J} nⱼ is computed over all partitions in the group. Hierarchical strategies can to converge relatively quickly, but may do so sub-optimally because they neglect to explore

TABLE 2 shows examples of hyperpartition selection strategies that may be used within the system 100. A given strategy has a corresponding definition of reward, memory, and depth. In some embodiments, the user can specify the selection strategy on a per-data run basis. The user-specified strategy may be stored in the hyperpartition selection strategy attribute 204n of FIG. 2.

TABLE 2

| Name | Bandit Based? | Memory? | Recursive? |
|---|---|---|---|
| Uniform Random | N | N | N |
| UCB-1 | Y | N | N |
| Best-K | Y | Y | N |
| Best-K-Velocity | Y | Y | N |
| Recent-K | Y | Y | N |
| Recent-K-Velocity | Y | Y | N |
| Hierarchical-Alg | Y | N | Y |

Referring again to FIG. 5, in some embodiments, the processing of block 504 comprises:
(1) retrieve from the data hub 106 all hyperpartitions for the dataset and their associated nⱼ and all yⱼ∈Yⱼ rewards for this hyperpartition arm;
(2) using a specified hyperpartition selection strategy function H, choose the hyperpartition arm j that maximizes the H function, i.e. argmaxⱼ H(nⱼ, Yⱼ); and
(2) select a hyperpartition corresponding to arm j.

Having selected a hyperpartition to explore (block 504), blocks 506-512 correspond to a process for choosing the “best” parameterization within that hyperpartition. A Gaussian Process (GP) based modeling technique is employed to identify the best parameterizations given the models already built under that hyperpartition. The GP modeling is used to model the relationship between the continuous tunable parameters for the hyperpartition and the performance metric. In the following description, it is assumed that the selected hyperpartition has two optimizable (e.g., continuous and discrete) parameters α, γ. It will be appreciated that the technique can applied to generally any number of optimizable parameters greater than one.

At block 506, the performance of models previously evaluated for the dataset is modeled using GP. This may include retrieve from the data hub 106 all models that are built for this hyperpartition and their associated parameterization pᵢ{αᵢ, γᵢ} and performance yᵢ on the dataset.

In some embodiments, the system requires a minimum number of past performance data points before constructing the GP model (e.g., at least rₘᵢₙ models specified by attribute 204x of the data runs table 106b). If the minimum number of models has not yet been evaluated, block 506 may further include sampling parameterizations between the lower and upper limits for α and γ, training the sampled models, and storing the evaluated performance data in the data hub 106.

The performance yᵢ is modeled as a function of the parameters α, γ using the GP. Under the formulation of the GP, this will yield a function from

μ_{y}_{ᵢ},σ_{y}_{ᵢ}=f_{GP}(α,γ)

forming a hypothesis mapping vectors in [symbol] ² to the mean performance μᵢ and prediction variance σᵢ for a parameterization pᵢ{α, γ} on the dataset.

At block 508, proposal parameterizations pᵢ{αᵢ, γᵢ} are generated, where α∈[α_{lower}, αᵤₚₚₑᵣ] and γ∈[γ_{lower}, γᵤₚₚₑᵣ]. The proposed parameterizations may be generated exhaustively using any suitable technique, such as a Monte Carlo process.

At block 510, for each parameterization pⱼ, the performance yⱼ is estimated using the GP model to get μ_{y}_{ⱼ}, and σ_{y}_{ⱼ}, where μ_{y}_{ⱼ} is the maximum a posteriori value for yⱼ and σ_{y}_{ⱼ} expresses the confidence in the prediction.

At block 512, the proposed parameterization (i.e., model) maximizing an acquisition function is chosen. More particularly, for each μ_{y}_{ᵢ}, σ_{y}_{ᵢ}, pair, the acquisition function A is applied to generate a score

aⱼ=A(u_{y}_{ⱼ},σ_{y}_{ⱼ})

and the parameterization pⱼ with the highest corresponding aⱼ (i.e., argmaxⱼ aⱼ) is selected.

The acquisition function can be specified by the user via attribute 204m of the data runs table 106b. Non-limiting examples of acquisition functions include: Uniform Random, Expected Improvement (EI), and Expected Improvement per Time (EI Time). With Uniform Random, the system 100 randomly selects (using the uniform distribution) a single parameterization from the generated parameterizations for the hyperpartition. With EI, the parameterization is selected using both the average performance predicted by the GP model and also the confidence in its prediction, which can be calculated from the standard deviation. The EI criterion builds up from a standard z-score but taking the maximum y-value seen so far. Let y_{best} be the best y seen so far among the yᵢ's. First a z-score is calculated for every yᵢ

$$γ ( \frac{{y}_{best} - {μ}_{{y}_{j}}}{{σ}_{{y}_{j}}} )$$

The expected improvement for some unseen x parameterization can be written as

α_{EI(y}_{ᵢ}₎=σ(γ(yⱼ)Φ(γ(yⱼ))*N(γ(yⱼ))).

EI Time is identical to EI, except that the acquisition function is multi-objective on the performance of a parameterization once trained into a model by taking into account the time cost for training. The z-score formulation can be changed as such,

$$γ ( {y}_{j} ) = \frac{{y}_{best} - {μ}_{{y}_{j}}}{{t}_{{y}_{j}} {σ}_{{y}_{j}}}$$

training a single GP in the same manner and selecting an x using a_{EI}(x). The time cost for training t_{y}_{ⱼ} may be determined from, or estimated by, the elapsed time attribute 208o within the performance table 106d.

For EI and EI Time, the rₘᵢₙ parameter (i.e., attribute 204x in FIG. 2) is used to determine the minimum number of model trainings must take place before the system 100 starts using regression to guide its choices. This parameter balances exploration (high rₘᵢₙ) and exploitation (low rₘᵢₙ). In some embodiments, rₘᵢₙ is greater than or equal to two (2) and less than or equal to five (5).

At block 514, a model with the selected parameterization pⱼ is trained on the dataset and the performance yⱼ is recorded to the data hub 106. FIG. 7 shows illustrative training processing that may be the same as or similar to the processing of block 514.

The newly trained model can be used to update the MAB 520 (FIG. 5A). More specifically, the MAB 520 can use the new performance to update its correspond arm performance history 530. In some embodiments, the attribute 206e of the hyperpartitions table 106c is incremented based upon performance of the newly trained model.

The hybrid hyperpartition/parameterization optimization process of blocks 504-514 may be repeated until certain termination criteria are reached (block 516). The termination criteria can include whether desired performance is reached, whether a computational or time-based budget (or “deadline”) is met, or any other suitable criteria. If the termination criteria are reached, the highest performing model is returned at block 518.

FIG. 6 is a flowchart of a model recommendation and optimization method 600 for use within the system 100 of FIG. 1. The method 600 combines the ICRT routine of FIG. 4 with the hybrid optimization process of FIG. 5, along with user interface actions, to provide a multi-methodology, multi-user, self optimizing Machine Learning as a Service platform for shared computing that automates and optimizes the classifier training process and pipeline.

The illustrative method 600 begins at block 602, where a dataset is received. In some embodiments, the dataset is uploaded by user via the dataset upload UI 102a. The user can specify various parameters, such as the performance metric, a budget, k_{window}, rₘᵢₙ, priority, etc. At block 604, the dataset is stored within the repository 104b and a corresponding record data run record is generated and stored within data hub (i.e., within table 106b). The data run record may include user-specified parameters. In some embodiments, the processing of blocks 602 and 604 is performed by the dataset upload UI 102a.

At block 606, the ICRT routine 400 of FIG. 4 may be performed to recommend a modeling methodology, hyperpartition, or model for use with the dataset. At block 408, the hybrid optimization process 500 of FIG. 5 is performed to find a suitable (and ideally the “best”) model for the dataset. To reduce search time and/or resource usage, the hybrid optimization process 500 may be restricted to the methodology/hyperpartition search space as recommended by the ICRT routine at block 606.

At block 610, the optimized (or best performing) model is returned. The model may be returned to the user via a UI 102 and/or via email. In some embodiments, a trained model may be returned from the repository 104c. For example, the system may return a trained classifier which forms a hypothesis mapping features to labels.

The processing of blocks 602-610 may be performed by one or more worker nodes 110 coordinated via the data hub 106. In some embodiments, the method 600 commences when a worker node 110 detects a new data run record within the data runs table 106b (e.g., by querying the started timestamp 204b shown in FIG. 2).

It will be appreciated that the illustrative method 600 uses a two-part technique to find the “best” model for a dataset: an ICRT routine (block 606) and a hybrid optimization process (block 608). The techniques are complementary, in that a methodology/hyperpartition recommended by the ICRT routine could be used as input to narrow the optimization search space. Although the techniques can be used together, as shown, it should be understood that they could also be used separately. For example, the system could invoke the ICRT routine to recommend a methodology/hyperpartition/model, without invoking the hybrid optimization process. Alternatively, the system could invoke the hybrid optimization process to find a suitable model without invoking the ICRT routine.

The method 600 may be performed entirely within the system 100. For example, a user could upload a dataset (via the dataset upload UI 102a) and the processing cluster 108 can perform the method 600 in a distributed manner to find a suitable model for the dataset. Alternatively, at least some of the processing of method 400 may be performed external to the system 100. For example, in the case where user is not able to upload their dataset to the system 100, the user can interact with the system using an API as follows. The user requests candidate models from the system 100, optionally specifying the number of candidate models to be returned. The system 100 randomly selects candidate models from the set of modeling possibilities and returns corresponding information to the user in a suitable form, such as a configuration file formatted using JavaScript Object Notation (JSON). Based on this response, the user can train the candidate models on their local system to evaluate the performance of each candidate model using cross-validation or any other desired performance metric. Again using the API, the user uploads the performance data to the system 100 and requests new modeling recommendations. The system 100 stores the user's performance data, correlates it against performance data against that of previously seen datasets, and provides new model recommendations, which can be returned to the user as configuration files.

In this workflow, a user does not have to share or submit any data to the system 100. This not only allows users to access the power of the system 100, but also contributes entries to the data-model matrix thus increasing the experiences from which the system could learn as time goes on. This enables other users to find better models for their dataset (so-called “collaborative learning”).

The systems and methods described above can also be used to handle very large datasets (i.e., “big data”). For example, the system can break down a large dataset into smaller chunks and process individual chunks using the techniques described above so as to find the “best” model for each chunk independently. The independent models can then be fused into a “meta model” that performs well over the entire dataset. A meta models is an ensemble created as a result of taking hyperpartition leaders (models with the best performance in each hyperpartition) and fusing them together to achieve higher performance. In one embodiment the fusing is accomplished, for example, by utilizing either a voting technique (e.g., majority or plurality voting), an averaging technique with or without outliers (e.g., for regression), or a stacking technique in which the outputs of the ensemble are used as features to a final fusing classifier. Other techniques for fusing individual classifiers and predictions may also be used.

FIG. 7 is a flowchart of a model training process 700 for use within the system of FIG. 1 and, more specifically, within the ICRT routine 400 of FIG. 4 and/or the hybrid optimization process 500 of FIG. 5. The process 700 can be used to train a single model on a given dataset, representing a discrete job (or “task”) that can be performed by a worker node 110.

At block 702, a model to train is selected by querying the performance table 106d. In various embodiments, this includes querying the started timestamp 208m (FIG. 2) to find a job that has not yet been started. At block 704, the model is trained on the dataset and, at block 706, the trained model may be stored in the repository 104c (e.g., at the location specified by model path attribute 208e of FIG. 2). At block 708, the performance of the trained model is determined using the metric specified on the data run (e.g., attribute 204v of FIG. 2) and, at block 710, the performance record is updated with the determined performance. For example, the performance mean and standard deviation attributes 208i, 208j may be assigned. Other attributes of the performance record may also be assigned, such as the started timestamp, the completed timestamp and elapsed time attributes 208m, 208n, 208o. A corresponding hyperpartition record may also be updated within the data store. Specifically, the number of models trained attribute 206d may be incremented to indicate that another model has been trained for the corresponding hyperpartition and dataset.

When performing process 700, a worker node 110 may consider the user-specified budget, as shown by block 712. For example, if a wall time budget is exhausted, the worker node 110 may determine that process 700 should not be performed for the data run. As another example, if a wall time budget is nearly exhausted, the worker node 110 may terminate the process 700 prematurely based upon elapsed wall time.

FIG. 8 shows an illustrative computer or other processing device 800 that can perform at least part of the processing described herein. In some embodiments, the system 100 of FIG. 1 includes one or more processing devices 800, or portions thereof. The illustrative processing device 800 includes a processor 802, a volatile memory 804, a non-volatile memory 806 (e.g., hard disk), an output device 808 and a graphical user interface (GUI) 810 (e.g., a mouse, a keyboard, a display, for example), each of which is coupled together by a bus 818. The non-volatile memory 806 stores computer instructions 812, an operating system 814, and data 816. In one example, the computer instructions 812 are executed by the processor 802 out of volatile memory 804. In one embodiment, an article 580 comprises non-transitory computer-readable instructions.

Processing may be implemented in hardware, software, or a combination of the two. In embodiments, processing is provided by computer programs executing on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as special purpose logic circuitry (e.g., an FPGA (field programmable gate array) and/or an ASIC (application-specific integrated circuit)).

All references cited herein are hereby incorporated herein by reference in their entirety.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that that scope of protection sought herein should not be limited to the described embodiments but rather should be limited only by the spirit and scope of the following claims.

What is claimed is:

1. A system to automate selection and training of machine learning models across multiple modeling methodologies, the system comprising:
a model methodology repository configured to store one or more model methodology implementations, each of the model methodology implementations associated with a modeling methodology;
a dataset repository configured to store datasets;
a data hub configured to store data run records and performance records;
a dataset upload interface (UI) configured to receive a dataset, store the received dataset within the dataset repository, to generate a data run record comprising the location of received dataset within the dataset repository, and to store the generated data run record to the data hub; and
a processing cluster comprising a plurality of worker nodes, each of the worker nodes configured to select a data run record from the data hub, to select a dataset from the dataset repository, to select a modeling methodology from the model methodology repository; to generate a parameterization within with the model methodology, to generate a model having the selected modeling methodology and generated parameterization, to train the generated model on the selected dataset, to evaluate the performance of the trained model on the selected dataset, to generate a performance record, and to store the generated performance record to the data hub.

2. The system of claim 1 wherein each of the data run records comprising a dataset location identifying one of the stored datasets within the dataset repository, wherein the each of the worker nodes is configured to select a dataset from the dataset repository based upon the dataset location identified by the data run record.

3. The system of claim 2 wherein each of the performance records is associated with a data run record and a modeling methodology, each of the performance records comprising a parameterization within the associated modeling methodology and performance data indicating the performance of the model parameterization on the associated dataset, wherein each of the worker nodes is configured to and to generate a performance record comprising the evaluated performance and associated with the selected data run, the selected modeling methodology, and the generated parameterization.

4. The system of claim 2 wherein the dataset UI is further configured to receive one or more parameters and to store the one of more parameters with a data run record.

5. The system of claim 4 wherein the parameters include a wall time budget, a performance threshold, number of models to evaluate, or a performance metric.

6. The system of claim 5 wherein at least one of the worker nodes is configured to correlate the performance of models on a first dataset to the performance of models on a second dataset.

7. The system of claim 5 wherein at least one of the worker nodes is configured to use a Bandit strategy to optimize a model for a dataset.

8. The system of claim 7 wherein the parameters include a Bandit strategy memory type, a Bandit strategy reward type, or a Bandit strategy grouping type.

9. The system of claim 7 wherein at least one of the worker nodes is configured to use a Gaussian Process (GP) model to select a model for a dataset, wherein the selected model maximizes an acquisition function.

10. The system of claim 9 wherein the parameters include the acquisition function.

11. The system of claim 1 further comprising a trained model repository, wherein at least one of the worker nodes is configured to store a trained model within the trained model repository.

12. A method for machine learning comprising:
(a) generating a plurality modeling possibilities across a plurality of modeling methodologies;
(b) receiving a first dataset;
(c) selecting a first plurality of models from the modeling possibilities;
(d) evaluating a performance of each one of the first plurality of models on the first dataset;
(e) receiving a second dataset;
(f) selecting a second plurality of models from the modeling possibilities;
(g) evaluating a performance of each one of the second plurality of models on the second dataset;
(h) receiving a third dataset;
(i) selecting a third plurality of models from the modeling possibilities;
(j) evaluating a performance of each one of the third plurality of models on the third dataset;
(k) generating a first performance vector comprising the performance of each one of the first plurality of models on the first dataset;
(l) generating a second performance vector comprising the performance of each one of the second plurality of models on the second dataset;
(m) generating a third performance vector comprising the performance of each one of the third plurality of models on the third dataset;
(n) selecting from the first and second datasets, the most similar dataset based upon comparing a similarity between the first and third performance vectors and a similarity between the second and third performance vectors;
(o) among the models trained for the most similar dataset, select the one with the highest performance on the most similar dataset;
(p) evaluating a performance of the selected model on the third dataset;
(q) add the performance of the selected model on the third dataset to the third performance vector; and
(r) returning a model from the third performance vector having a highest performance of models in the third performance vector.

13. The method of claim 12 wherein the steps (n)-(r) are repeated until the model having the highest performance from the third performance vector has a performance greater than or equal to a predetermined performance threshold.

14. The method of claim 12 wherein the steps (n)-(r) are repeated until a predetermined wall time budget is exceeded.

15. The method of claim 12 wherein the steps (n)-(r) are repeated until performance of a predetermined number of models is evaluated.

16. The method of claim 12 wherein evaluating the performance of each one of the first plurality of models on the first dataset comprises storing a plurality of performances records to a database, wherein generate a first performance vector comprising the performance of each one of the first plurality of models on the first dataset comprises retrieving the first plurality of performance records from the database, wherein each of the plurality of performance records is associated with the first dataset and one of the first plurality of models, wherein each of the plurality of performance records comprises performance data indicating the performance of the associated model on the first dataset.

17. The method of claim 12 further comprising:
estimating the performance of one or more of the modeling possibilities not in the third plurality of models on the third dataset using collaborative filtering or matrix factorization techniques; and
adding the estimated performances to the third performance vector.

18. The method of claim 12 wherein generating a plurality modeling possibilities across a plurality of modeling methodologies comprises:
enumerating a plurality of hyperpartitions across a plurality of modeling methodologies; and
for optimizable model parameters and hyperparameters, choose a feasible step size to derive a plurality of modeling possibilities.

19. A method for machine learning comprising:
(a) receiving a dataset;
(b) enumerating a plurality of hyperpartitions across a plurality of modeling methodologies;
(c) generating a plurality initial models, each of the initial models associated with one of the plurality of hyperpartitions;
(d) evaluating a performance of each of the plurality of initial models on the dataset;
(e) providing a Multi-Armed Bandit (MAB) comprising a plurality of arms, each of the arms corresponding to at least one of the plurality of hyperpartitions;
(f) calculating a score for each of the MAB arms based upon the performance of evaluated models associated with the corresponding at least one of the plurality of hyperpartitions;
(g) choosing a hyperpartition based upon the MAB arm scores;
(h) generating a Gaussian Process (GP) model using the performance of evaluated models associated with the chosen hyperpartition;
(i) generating a plurality of proposed models, each of the modeling possibilities associated with the chosen hyperpartition;
(j) estimating a performance of each of the proposed models using the GP model;
(k) choosing a model from the proposed models maximizing an acquisition function;
(l) evaluating the performance of the chosen model on the dataset; and
(m) returning a model having the highest performance on the dataset of the models evaluated.

20. The method of claim 19 wherein the steps (f)-(l) are repeated until a model having the highest performance on the dataset has a performance greater than or equal to a predetermined performance threshold.

21. The method of claim 19 wherein the steps (f)-(l) are repeated until a predetermined wall time budget is exceeded.

22. The method of claim 19 wherein providing MAB comprises providing a MAB comprising a plurality of arms, each of the arms corresponding to at least two of the plurality of hyperpartitions associated with the same modeling methodology.

23. The method of claim 19 wherein calculating a score for each of a MAB arm comprises calculating a score based upon the performance of the most recent K evaluated models associated with the corresponding at least one of the plurality of hyperpartitions.

24. The method of claim 19 wherein calculating a score for each of a MAB arm comprises calculating a score based upon the performance of a best K evaluated models associated with the corresponding at least one of the plurality of hyperpartitions.

25. The method of claim 19 wherein calculating a score for each of a MAB arm comprises calculating a score based upon an average performance of evaluated models associated with the corresponding at least one of the plurality of hyperpartitions.

26. The method of claim 19 wherein calculating a score for each of a MAB arm comprises calculating a score based upon a derivative of the performance of evaluated models associated with the corresponding at least one of the plurality of hyperpartitions.

27. The method of claim 19 wherein choosing a hyperpartition based upon the MAB arm scores comprises choosing a hyperpartition using an Upper Confidence Bound-1 (UCB1) algorithm.
